(19) United States
(12) Patent Application Publication
(10) Pub. No.: US 2010/0278344 A1
(43) Pub. Date: Nov. 4, 2010

(54) System, Portable Object and Terminal for Decrypting Encrypted Audio and/or Video Data

(75) Inventor: Alain Rhelimi, Ceyreste (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Meudon (FR)

(21) Appl. No.: 12/808,740

(22) PCT Filed: Dec. 17, 2008
(86) PCT No.: PCT/EP2008/067802

§ 371 Date: Jun. 24, 2010

(30) Foreign Application Priority Data
Dec. 20, 2007 (EP) 07301724.6

(51) Int. Cl. H04L 9/00

(52) U.S. Cl. 380/277

(57) ABSTRACT

The invention relates to a system (10) for decrypting encrypted audio and/or video data. The system includes a terminal (13) and at least one portable object (14). The terminal and/or the portable object include means for receiving ciphered audio and/or video data from outside the system, means for determining at least one decrypting key, and means for decrypting the encrypted audio and/or video data. Said at least one decrypting key is necessary for decrypting the encrypted audio and/or video data. According to the invention, the terminal and at least one portable object each include at least one contactless communication interface for exchanging data relative to at least one decrypting key, encrypted audio and/or video data and/or decrypted audio and/or video data. The invention also relates to a corresponding portable object and to a corresponding terminal.

### TECHNICAL FIELD OF THE INVENTION

The invention generally relates to a system for decrypting encrypted audio and/or video data.

For this purpose, the system includes a terminal and one or several portable objects intended to cooperate with the terminal. In addition, the terminal and/or the portable object or objects include means for receiving from the outside, encrypted audio and/or video data, means for determining at least one decrypting key and means for decrypting the encrypted audio and/or video data. The decrypting key or keys is/are necessary for decrypting the encrypted audio and/or video data.

In addition, the invention also relates to such a portable object.

Then, the invention also relates to such a terminal.

### STATE OF THE ART

Among the transmission standards which are renowned for providing a service broadcasting data to mobile or fixed equipment, we can be mention:
DVBH (the acronym for “Digital Video Broadcasting—Handheld”);
DAB (the acronym for “Digital Audio Broadcasting”);
DMB (the acronym for “Digital Multimedia Broadcasting”);
ISDB-T (the acronym for “Integrated Services Digital Broadcasting—Terrestrial”); and
MBMS (the acronym for “Mobile Broadcast Multicast Service”).

As regards the transmission standard DVB-H, for a mobile broadcasting application, for example, using a mobile telephone connected through a radiotelephony network to a server providing an encrypted content is known.

The server broadcasts, through the radiotelephony network, encrypted data. The encrypted data more particularly include encrypted audio and video data.

In order to decrypt the encrypted audio and video data, the mobile telephone is more particularly provided with a communication interface with the radiotelephony network, a contact communication interface with a chip card, a screen and a loudspeaker.

The mobile telephone is provided for receiving, through the communication interface with the radiotelephony network, from the server, the broadcast encrypted data.

The mobile telephone decrypts the encrypted audio and video data in order to obtain a flow of uncoded audio and video data.

In order to decrypt the encrypted data, the mobile telephone cooperates with a chip card of the “SIM” (the acronym for “Subscriber Identity Module) type, also called a SIM card. The SIM card is provided in addition to an application for authentifying the holder thereof, more particularly enabling the connection to an operator's radiotelephony network with a decrypting application relative to one or several decrypting key or keys.

In addition, the mobile telephone is adapted to decrypt the encrypted audio and video data using the data relative to one or to several decrypting key or keys exchanged with the SIM card through the contact communication interface of the ISO 7816 type (the acronym for “International Standards Organization”).

When the audio and video data are decrypted, the mobile telephone continuously transmits the video data to the screen for the display thereof and the audio data to the loudspeaker for the broadcasting thereof.

However, such a known solution has some major drawbacks.

First, such a solution based on the utilisation of a mobile telephone requires a contract to be signed between the user of the SIM card and the radiotelephony operator or MNO (the acronym or “Mobile Network Operator”), in order to take advantage of the broadcasting application from a server providing an encrypted content.

In addition, the utilisation such a solution is little flexible to access the server through a radiotelephony network. As a matter of fact, for example if the user has to change the radiotelephony operator, he or she must sign a new contract with the provider of the encrypted content directly or indirectly managing the server. Such a change in the radiotelephony operator requires finding a new radiotelephony operator giving access to the server through its own network. Thus, it is necessary for the server to be accessible through several radiotelephony networks implying several radiotelephony operators.

However, the change in the radiotelephony operator also implies a change of SIM card. Changing the SIM card requests the intervention of the final user. The final user is then obliged to remove the removable current SIM card positioned within the host mobile telephone to insert a new SIM card depending on the new radiotelephony operator.

Now, such SIM card extraction and insertion operations require a lengthy, boring or even crippling disassembling then reassembling of the host mobile telephone to access the server. Consequently, the final user strongly depends on the radiotelephony operator giving him or her access to the server. Such a strong dependence does not favour changing the radiotelephony operator and thus does not favour the mobility of the final user between various radiotelephony operators.

Then, such a solution lacks interoperability through various types of telecommunication networks to access the server. In other words, such a solution is not compatible with another telecommunication network than the radiotelephony network to access the server. As a matter of fact, using only a SIM card, as explained above, does not help decrypting the encrypted content supplied through the other telecommunication network than the radiotelephony network. Thus, the final user cannot take advantage of the mobile broadcasting application through a wire network using the SIM card only, for example, in cooperation with a personal computer (or PC, the acronym for “Personal Computer”) as a terminal connected to an Internet wire network or with a decoder (or “set-up box”) as the terminal.

### SUMMARY OF THE INVENTION

The invention gets rid of the above-mentioned major drawbacks by providing a system for decrypting encrypted audio and/or video data.

More particularly, the invention is a system for decrypting encrypted audio and/or video data. The system includes a terminal and at least a portable object. The terminal and/or the portable object include means for receiving encrypted audio and/or video data from outside the system, means for determining at least one decrypting key and means for decrypting the encrypted audio and/or video data. Said at least one decrypting key is necessary for decrypting the encrypted audio and/or video data.

According to the invention, the terminal and at least one portable object each include at least one contactless communication interface for exchanging data relative to at least one decrypting key, encrypted audio and/or video data, and/or decrypted audio and/or video data.

The general principle of the invention thus relies on a new approach wherein the architecture used for the communication between a terminal and one (or several) portable object or objects is not a contact interface such as the one used for the solution of the prior art explained above, but one or several contactless interfaces.

“Contactless communication interface” also mentioned above as a “contactless interface” means a communication interface provided within an entity, as the sender or receiver of data, not requiring to come into contact with or physically touching a matching interface provided within another entity as the receiver or sender of data to be able to communicate.

Through the contactless interface or interfaces, the terminal and at least some implied portable objects exchange, in order to decrypt the encrypted audio and/or video data, data without requiring a physical motion closer, which can even be a contact such as the one required for the known solution.

It should be noted that the invention imposes no constraint as regards the direction of the data exchange between the terminal and the portable object.

In addition, either the terminal or the portable object, as an entity of the system, determines the whole or a part of the decrypting keys, and transmits data relative to one or several encrypting key(s) to the other system entity, either the portable object or the terminal respectively, so that the other entity decrypts the encrypted audio and/or video data using the received decrypting key or keys.

In addition, the entity of the system having decrypted the audio and/or video data can transmit to the other entity of the system the audio and/or video data, as decrypted. The other entity of the system can be capable of displaying on at least one screen the decrypted video data received, and/or to broadcast through at least one loudspeaker, the decrypted audio data received.

The terminal only requires a simple interface or simple proximity communication interface(s) with a personal network connecting the terminal with the portable object or each portable object.

In addition, the communication of the terminal with the same portable object can occur, in one communication direction, through a first contactless interface and in another communication direction through a second contactless interface. Such a selection of the contactless interface to be used can be made for several reasons, for example for reasons relating to the maximum rate inherent in the available contactless interfaces and/or for reasons relative to the security of the communication proper.

Contrary to the known solution mentioned above, the invention imposes no constraint on the way of supplying the system with the encrypted audio and/or video data to be decrypted. This can particularly be a server transmitting, independently of the radiotelephony network, the encrypted audio and/or video data to be decrypted, for example through a network of the wire or Internet or Intranet wireless types. Thus, there is no need to authentify neither on the radiotelephony network nor on a communication network of any other nature whatsoever through which the final user of the system receives, through the system, the enciphered audio and/or video data.

The utilisation of a contactless interface, instead of a contact interface, results in making it possible not to be linked to only one wire or wireless network operator.

As a matter of fact, the portable object is not as closely linked to the terminal as in the above-mentioned solution. Thus, the architectural context used allows access to a server without necessarily operating only one wire or wireless network.

The possibility of accessing content, for example of the multi-media type, is thus increased, which facilitates the deployment and management thereof.

In other words, the only constraint imposed to the system consists in being able to receive, through the telecommunication network, encrypted audio and/or video data from the server. Thus, the final user can select the telecommunication network among all the others which are linked, through the system, to the server.

For example, the architecture used can operate a terminal and several portable objects, through the personal network, implemented for the communication.

Finally, because of the contactless interface, it is not necessary to mechanically handle the system for matching/unmatching a portable object with/from the terminal and reversely. As a matter of fact, no assembling or disassembling of the terminal implied for accessing the portable object is required prior to matching the latter with the same terminal (or, possibly, to another terminal), to go on following a flow of processed and decrypted data within the system.

According to another aspect, the invention is a portable object for deciphering encrypted audio and/or video data. The portable object includes means for determining at least one decrypting key. Said at least one decrypting key is required for decrypting the encrypted audio and/or video data.

According to the invention, the portable object includes at least one contactless communication interface for exchanging, with outside the portable object, data relative to at least one decrypting key, encrypted audio and/or video data, and/or decrypted audio and/or video data.

It should be understood that using one or several contactless interfaces gives a secure freedom of movement to the holder of the portable object, while remaining connected, with respect to a terminal or to another portable object to be matched, or already matched, or to be unmatched, using a contact interface. A continuous service, i.e. processing of this flow of encrypted audio and/or video data is thus easily secured.

Thus, contrary to the known solution examined above, using a contactless interfacing technology increases the flexibility of the utilisation of the portable object at issue.

Such a portable object is free of any telecommunication operator which makes it compatible with any telecommunication network connected to the server providing encrypted audio and/or video data. In other words, such a portable object is independent of any radiotelephony network operator.

As a portable object, it can have different shapes. It can consist, for example, of a “dongle” (requiring no specific reader to have access to one or several application(s) it supports), an earpiece or a key chain provided with one or several proximity contactless interface or interfaces (of the radiofrequency type, for example of the Bluetooth, Wibree, Wifi, Zigbee, NFC (acronym for “Near Field Communication”), or infrared) types and/or of the wireless USB (the acronym for “Universal Serial Bus”) type.

According to another aspect, the invention is a terminal for decrypting encrypted audio and/or video data. The terminal includes means for receiving from outside the terminal encrypted audio and/or video data, at least one decrypting key being necessary for decrypting the encrypted audio and/or video data.

According to the invention, the terminal includes at least one contactless communication interface for exchanging with outside the terminal data relative to at least one decrypting key, encrypted audio and/or video data, and/or decrypted audio and/or video data.

It should be understood that using one or several contactless interface(s) within the terminal increases the number of simultaneous or time-shifted potential interlocutors.

In addition, using one or several contactless interfaces within the terminal facilitates the delegation of one or several function(s), previously assigned to the terminal, to other entities outside the terminal, such as one or several portable object(s), with respect to a portable object to be matched or unmatched, with respect to a known terminal communicating through a contact interface.

### DESCRIPTION OF THE DRAWINGS

Other characteristics and advantages of the invention will appear upon reading the description of a unique embodiment, given only as a non-limitative but indicative example and the appended drawings, on which:

FIG. 1 shows a simplified diagram of an example in which a system according to the invention is connected to a server providing the encrypted content;

FIG. 2 illustrates a simplified diagram of the system of FIG. 1, wherein a terminal interacts, through a contactless interface, with a portable object to decrypt the encrypted audio and video data;

FIG. 3 shows a detailed diagram of a portable object of the system in FIG. 2.

### DESCRIPTION OF THE UNIQUE EMBODIMENT

The embodiment explained in connection with the appended figures does not aim at reducing the range of the invention, and then many modifications can be brought thereto without leaving the scope of the invention.

The embodiment of the invention described hereinunder relates to the application of broadcasting of encrypted audio and video data relative to television.

Of course, the invention can also apply to an application of broadcasting of encrypted data which are strictly audio data or strictly video data.

The invention particularly aims at having a final user taking advantage of a multimedia content through other ways than the one known using only one wireless telecommunication network composed of a radiotelephony network.

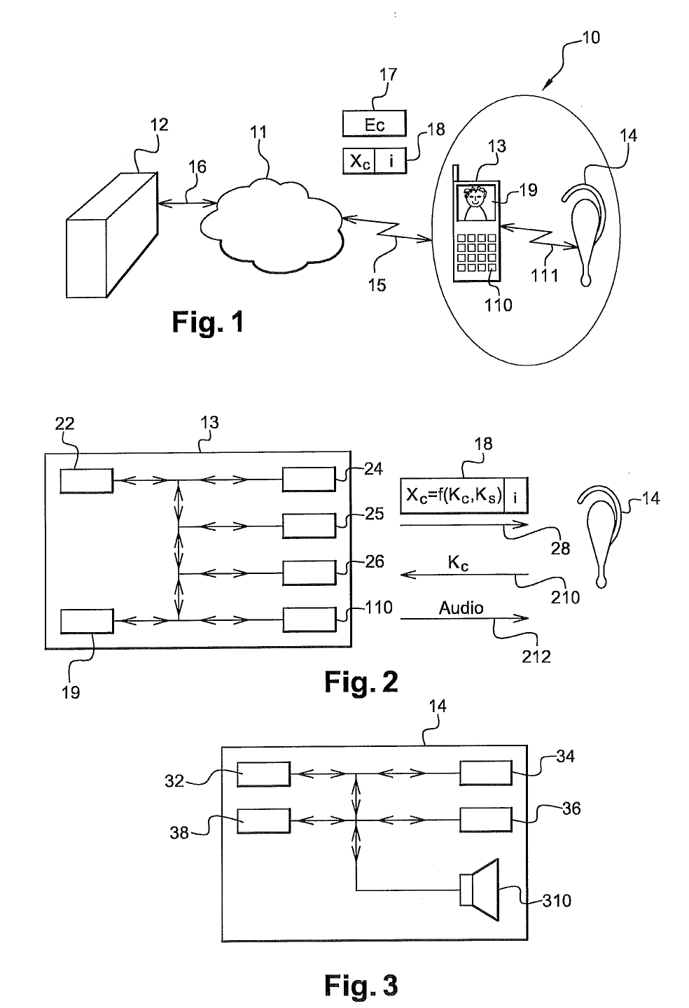

As shown as an example in FIG. 1, an electronic system 10 is remotely linked, through a telecommunication network 11, with a remote broadcasting server 12, as the provider of encrypted audio and/or video data.

It should be noted that the telecommunication network 11 is independent of any other radiotelephony network.

A final user of the system 10 wishes to access a not encoded or plain audio and video content provided in an encrypted way by the server 12.

The server 12 may be accessible through various types of telecommunication networks (not shown) and in addition, for a same type of telecommunication network through various telecommunication networks (not shown).

The server 12 broadcasts encrypted audio and video data Ec carried by content messages 17.

The encrypted audio and video data Ec can relate, for example, to a live or recorded television programmes or to a video on demand programme service.

In addition, the server 12 broadcasts data Xc relative, on the one hand, to a so-called content decrypting key Kc, and on the other hand, a so-called service decrypting key Ks transferred through service messages 18.

The data Xc relative to the content decrypting key Kc and the service key Ks match the encrypting of the content decrypting key Kc using the unique service decrypting key Ks not broadcast.

It should be reminded that one decrypting key corresponds to the encrypting key when one encrypting algorithm used is of a symmetrical type, such as the DES (the acronym for “Data Encrypting Standard”).

In order to simplify this description, any encrypting key matches a decrypting key.

Of course, other encrypting algorithms, such as an encrypting algorithm of the asymmetrical type, can also be used without leaving the scope of the invention.

In addition, the server 12 also broadcasts encrypted data relative to an index i of the service decrypting key Ksi to be used, and transferred through services messages 18. The data relating to the index i of the service decrypting keys Ks are used to identify, among a plurality of service decrypting keys Ks, only one service decrypting key Ksi. All the service decrypting keys Ks1, Ks2, Ks3 are stored within the system 10.

The index i identifies the correct service decrypting key Ksi required for determining the content decrypting key Kc.

The content deciphering key Kc is to be used for deciphering the encrypted audio and video data Ec.

To get connected to the server 12, the system 10 of the invention not necessarily requires a previous agreement with a radiotelephony operator to take advantage of a mobile broadcasting service.

It is sufficient for the system 10 to collect or include data making it possible to determine one or several decrypting key(s) required for decrypting the encrypted audio and video data.

Such data relative to the decrypting key or keys to be used for decrypting the encrypted audio and video data are supplied, for example, in the form of a subscription to a broadcasting service from the server independently from the telecommunication network 11 operated to get connected to the server 12.

The final user thus needs not authentify on a radiotelephony network to take advantage of the broadcasting service.

The system 10 of the invention may simply be based on an agreement with an operator providing content independently of the telecommunication network operator to access the encrypted audio and video data Ec delivered by the server 12.

The system 10 is provided for receiving from the server 12 and from the telecommunication network 11 the content messages 17 and the service messages 18.

The system 10 is adapted for determining, from the service messages 18, the service decrypting key Ksi to be used, then, to deduce therefrom the corresponding content decrypting key Kc.

With the service Ksi and content Kc decrypting keys associated with the service decrypting key Ksi being determined, the system 10 is adapted for decrypting the encrypted audio and video data Ec using the content decrypting key Kc.

The system 10 includes a terminal 13 and a portable object 14.

In this patent document, the term “terminal” means a piece of equipment located at the end of the telecommunication network 11 operated.

The terminal 13 includes a screen 19 for displaying data and a keyboard 110. The keyboard 110 is used by the final user to select, for example, first the server 12 or another server (not shown) accessible from the system 10, then, possibly a broadcasting programme among those supplied by the selected server 12.

The portable object 14 interacts with the terminal 13 by exchanging messages. The portable object 14 is intended to cooperate with the terminal 13 for decrypting the encrypted audio and video data Ec using encrypted data Xc, i relative to the two service decrypting key Ks and content decrypting key Kc, and the index i identifying the service decrypting key Ksi to be used.

Preferably, the means for determining the decrypting key of the content key Kc and the means for memorising the service decrypting key or keys are dissociated from terminal 13 and provided within the portable object 14, which the terminal 13 interacts with.

The system 10 composes at least partly mobile equipment. Mobility of the system 10 is more particularly the result of the portable object 14 carried by the final user.

Such mobility is made possible because the terminal 13 and the portable 14 are adapted for exchanging data, each using a contactless interface. Then, the terminal 13 and the portable object 14 exchange via a radiofrequency link 111.

The contactless interface used on either side within the system 10 is of the radiofrequency type.

According to an alternative embodiment, the contactless interface used on either side within the system 10 is of the infrared type.

According to another alternative embodiment, the terminal 13 and the portable object 14 are equipped with several contactless interfaces of the radiofrequency and/or infrared types to exchange such data.

The system 10 is capable of decrypting the encrypted audio and video data at the server 12.

The system 10 is intended to receive, from the outside, via an at least unidirectional radiofrequency link 15, i.e. from the communication network 11 to the system 10, the encrypted data broadcast. The figures include the encrypted audio and video data Ec and the encrypted data Xc relative to the two service Ks and content Kc decrypting keys and the data relative to the index i identifying the service decrypting key Ksi to be used.

According to an alternative embodiment (not shown) the system is connected via a wire connection to the communication network 11.

To receive the encrypted audio and video data Ec, the system 10 includes means for communicating via the radiofrequency connection 15 with the communication network 11.

The system 10 connected through the network 11 to the server 12 requires no authentication through the communication network 11 but an at least unidirectional wire link 16, i.e. through the server 12 to the communication network 11.

The communication network 11 includes an infrastructure composed of one or several wire and/or wireless network(s), with each network being composed of several communication relay elements. The communication network 11 is connected to the server 12 through the wire link 16. The wire link 16 is, for example, relative to a network of the Internet or Intranet type.

According to an alternative embodiment (not shown), the communication network link is connected, via an at least unidirectional radiofrequency connection, i.e. from the server 12 to the communication network 11, to the server 12.

The server 12 is directly or indirectly managed by the operator providing the content.

In addition the server 12 is connected through a wire link to a central unit (not shown). The central unit is capable of delivering or updating data intended to the server 12, so that the latter encrypts the data or not. The central unit and the server 12 are, for example, located within premises managed by the operator providing the content. The operator providing the content gives access to his or her preferred server through several telecommunication networks. The server 12 encrypts the audio and video data itself, as supplied by the central unit, possibly using data relative to matching content and service encrypting keys provided by the central unit.

The server 12 transmits to the system 10, through the wire link 16, the communication network 11 and the radiofrequency link 15, a flow of encrypted audio and video data Ec and encrypted data Xc relative to two service Ksi and content Kc decrypting keys and data relative to the index i of the service decrypting key Ksi.

The encrypted audio and video data Ec using service Ksi and content Kc encrypting keys are transmitted, simultaneously with encrypted data relative to the encrypted service Ks and content Kc decrypting keys and the data relative to the index i of the service decrypting key to be used.

The flow of encrypted audio and video data Ec is carried via a first dedicated transmission channel.

Similarly, the encrypted data Xc relative to two service Ks and content Kc decrypting keys and the data relative to the index i of the service decrypting key are carried via a second dedicated transmission channel. The first and second transmission channels dedicated are separate from each other.

According to an alternative embodiment, the flow of encrypted audio and video data Ec and the encrypted data Xc relative to two service Ks and content Kc deciphering keys and the data relative to the index i of the service decrypting key are carried via only one transmission channel.

Optionally, the server 12 is able to scramble the content 17 and service 18 messages. The system 10 is able to descramble the content and service messages received as scrambled messages, for retrieving the original content 17 and service 18 messages.

Preferably, the service decrypting key Ksi is regularly updated through a change in index i. In addition, an updating period is predetermined and is, for example, equal to one month.

Such an updating is, for example, provided by changing the index i of the service decrypting key Ks to be used among the set of possible service decrypting keys Ks.

The value of the service decrypting key Ksi for the same index can be updated on a longer period, for example one year.

The value of the service decrypting key Ksi for a same index may not be updated, having for example a disposable portable object 14 containing various service decrypting keys Ksi valid for a period of one year.

Preferably, the content decrypting key Kc is updated. The content decrypting key Kc is regularly updated with a period, for example, equal to ten seconds.

Such an updating is, for example, provided by using a service message dedicated thereto which carries a new encrypted content decrypting key Kc transmitted from the server 12. The new content decrypting key Kc is supplied encrypted to the system 10, by the server 12, through the wire link 16, the communication network and the radiofrequency link 15, for example, via another transmission channel than the one used for the encrypted audio and video data Ec proper.

According to an alternative embodiment, several content decrypting keys Kc are pre-stored within the system 10 and valid for a predetermined duration, for example one year. According to such an alternative solution, no service decrypting key Ks is used. Then, the associated service messages do not carry the data Xc relative to two service key Ks and content decrypting key Kc and the data relative to the index i of the service decrypting key.

It should be noted that the updating period relative to this service decrypting key Ks is greater than the one relative to the content decrypting key Kc.

According to an alternative embodiment, the server 12 transmits through the wire connection 16, the communication network 11 and the radiofrequency link 15, to the system 10, a flow of encrypted audio and video data Ec using the unique content encrypting key Kc without transmitting the latter nor any other data relative to another decrypting key (particularly, no data relating to a service decrypting key Ks) is given. According to such an alternative, the system 10 has the only content decrypting key Kc stored within the memory of the non-volatile type. According to such an alternative, no other decrypting key is used to determine the content decrypting key Kc.

According to another alternative embodiment, the server 12 transmits, through the wire link 16, the communication network 11 and the radiofrequency link 15, to the system 10, a flow of audio and video data encrypted using the unique content encrypting key, and encrypted data relative to only one decrypting key. The data relates to the unique decrypting key making it possible to deduce the content decrypting key Kc.

FIG. 2 shows a particular embodiment of the system 10 implemented to decrypt the encrypted content supplied from the server 12 managed by the content provider.

The system 10 includes the terminal 13 and the portable object 14.

The terminal 13 may be mobile or fixed.

The terminal 13 is composed, for example, of a mobile telephone.

The terminal 13 can also be a personal digital assistant (or PDA, the acronym for “Personal Digital Assistant”), a personal computer (or Pc, the acronym for “Personal Computer”) and a TV set connected by radiofrequency channel and/or by a wire to the server 12.

The terminal 13 is provided, among other things, with a microprocessor 22, an antenna 24, a contactless interface 25, one or several memories symbolised by only one memory block 26, the display screen 19 and the keyboard 110.

The microprocessor 22 is the central core of the terminal 13 which processes the data and checks them, and tries the set of elements comprised within the terminal 13. The microprocessor 22 implements an operation system stored in the memory block 26 to operate the terminal 13.

The antenna 24 is used for communicating with the communication network 11.

The screen 19 is provided more particularly for displaying data belonging to a menu to select a server accessible from the terminal 13, and plain or decrypted video data supplied by the terminal 13.

The terminal 13 includes, as the contactless interface 25, a Bluetooth (trademark) interface, so as to make it possible to communicate with the outside through radiofrequency waves, and any other communicating object located in the vicinity, for example up to approximately ten metres.

The memory block 26 includes a memory of the non-volatile type, such as a memory of the ROM type (the acronym for “Read Only Memory”) and/or a memory of the Flash type. The non-volatile memory stores the operation system, an application programme or a data decrypting application using the content decrypting key Kc to decrypt the encrypted audio and video data. In addition, preferably, the non-volatile memory stores an application for decrypting the data relative to the content decrypting key Kc to be received from the portable object 14 through the Bluetooth interface 25. Eventually, the non-volatile memory stores an application for encrypting the audio data to be transmitted, through the Bluetooth interface 25, to the portable object.

It should be noted that the Bluetooth technology inherently provides the securing of data exchanged between two matched entities.

The portable object 14 and the terminal 13 securely exchange through the Bluetooth technology.

It appears very clearly that should the contactless technology used not integrate inherently a secured channel, it is then planned to secure the exchange channel between the portable object 14 and the terminal 13, for example using a cryptographic schema known per se, common to the portable object 14 and to the terminal 13.

The memory block 26 also includes a memory of the volatile type. The memory of the volatile type is intended to temporarily store more particularly the intermediate data belonging to the encrypting and decrypting calculations, as well as the data relative to the content decrypting key Kc received from the outside.

The terminal 13 is adapted for receiving, via the antenna 24, in the form of content messages, encrypted audio and video data Ec and in the form of service messages encrypted data Xc, i relative to the content decrypting key Kc and the service key Ksi, as well as the index i identifying the correct service decrypting key to be used.

The terminal 13 is adapted to redirect, through the Bluetooth interface 25, to the portable object 14, via a first radiofrequency link 28, the service messages 18 carrying the encrypted data Xc, i relative to the content decrypting key Kc, and the service key Ksi, and the index i identifying the correct service decrypting key to be used.

The terminal 13 is adapted for receiving by return from the portable object 14, through the Bluetooth interface 25, via a second radiofrequency link 210, the content decrypting key Kc.

The content decrypting key Kc is received, preferably encrypted. The terminal 13 is then able to decrypt the content decrypting key Kc.

The terminal 13 is adapted for decrypting the encrypted audio and video data Ec using the content decrypting key Kc received.

According to an alternative embodiment, the terminal is adapted to redirect the only encrypted audio data to an external portable object, also called the second portable object, via the Bluetooth interface 25, together with data relative to the content decrypting key Kc received from the first portable object. The first portable object is the one which determines the content decrypting key Kc prior to transmitting it to the terminal. The second portable object different form the first portable object is adapted to decrypt the encrypted audio data using the content decrypting key Kc received from the terminal. The terminal carries out a decrypting function on only video data using the content decrypting key Kc received from the first portable object. The terminal is, for the processing of the encrypted audio data, a simple intermediary playing the part of a driver to exchange with the various portable objects each carrying out a function dedicated thereto, i.e. the function of determining the content decrypting key Kc and a function of decrypting audio data respectively.

According to another alternative embodiment, the terminal is adapted for transmitting only the encrypted video data to an external portable object, also called the second portable object, via the Bluetooth interface 25, together with the data relative to the content decrypting key Kc received from the first portable object. The first portable object is the one which determines the content decrypting key Kc prior to transmitting it to the terminal. The second portable object different from the first portable object is adapted for decrypting the encrypted video data using the content decrypting key Kc received from the terminal. The terminal carries out a function of decrypting only the audio data using the content decrypting key Kc received from the first portable object. The terminal is for the processing of the video data encrypted, a simple intermediary playing the part of a dispatcher to exchange with the various other portable objects each carrying a function which is dedicated thereto, i.e. the function of determining the content of the decrypting key Kc and the video data decrypting function respectively.

According to still another alternative embodiment, the terminal is adapted for transmitting, via the Bluetooth interface 25, on the one hand, the encrypted video data to an external portable object, also called the second portable object, together with data relative to the content decrypting key received from the first portable object, and on the other hand, the encrypted audio data, to an external portable object, also called a third portable object, together with data relative to the content decrypting key received from the first portable object. The first portable object is the one which decrypts the content decrypting key Kc prior to transmitting it to the terminal. The second portable object different from the first portable object is adapted to decrypt the encrypted video data using the content decrypting key Kc received from the terminal. The third portable object different from the first portable object is adapted to decrypt the encrypted audio data using the content decrypting key Kc received from the terminal. According to another alternative solution, the second and third portable objects form the same unique portable object. According to another alternative, the first, second and third portable objects form only one portable object. The terminal carries out no decrypting function of audio/video encrypted data. The terminal is thus a simple intermediary playing the part of a dispatcher for exchanging with the various portable objects each carrying a function which is dedicated, i.e. a function of determining a content decrypting key Kc, a function of decrypting encrypted video data and a function of decrypting encrypted audio data respectively.

According to the embodiment shown, when the plain audio and video data Ec, which means not encrypted, are obtained, the terminal 13 is capable of displaying on its own screen 19 the video data, and to transfer, via the Bluetooth interface 25, the preferably encrypted audio data, to the portable object 14.

According to an alternative embodiment (not shown), the terminal 13 transmits through the Bluetooth interface, the video data to the portable object 14 provided, in addition with a screen, which received them through its own Bluetooth interface, to display these. The screen used for displaying the video data is not the one on the terminal 13 but a shifted screen provided on a Bluetooth feature provided with such an incorporated screen and one or several earphones as a portable object.

According to an alternative embodiment (not shown), the terminal 14 transmits through its Bluetooth interface, the video data towards another portable object provided with a screen, which receives these through its own Bluetooth interface, so as to display these. The screen used for displaying the video data is not the one of the terminal 13, but a shifted screen provide on a Bluetooth feature provided with such an integrated screen, as another portable object.

The portable object 14 is intended to interact with the terminal 13 for decrypting the encrypted content. The encrypted content includes encrypted audio and video data Ec and the encrypted data Xc, i relative, on the one hand, to the two content decrypting keys Kc, and service decrypting key Ksi, and on the other hand, to an index i identifying the pertinent service decrypting key to be used.

The portable object 14 receives, via a contactless interface, the encrypted data Xc, i relative, on the one hand, to the two content Kc and service Ksi decrypting keys, and on the other hand, to an index i identifying the pertinent service decrypting key to be used.

The encrypted data Xc relative to the two content Kc and service Ksi decrypting keys are the result of a predefined function f, which can be expressed as follows: Sc=f(Kc, Ksi).

The portable object 14 determines the content decrypting key Kc using the encrypted dtat Xc, i received from the terminal 13 and relative to the content decrypting key, and service decrypting key Ksi and the index i identifying the correct service decrypting key to be used, as explained hereinunder while referring to FIG. 3?

When the content decrypting key Kc is determined, the portable object 14 transmits it via the contactless interface periodically to the terminal 13 so as not to use the whole bandwidth. The content decrypting key Kc received by the terminal 13 makes it possible to decipher a part of the audio and video data.

The portable object 14 preferably includes at least one earphone for broadcasting at least some decrypted audio data and/or at least a screen for displaying at least some decrypted video data.

Preferably, the portable object 14 has such resources, i.e. more particularly a contactless interface for communicating with the outside, one or several earphones and/or one or several screens.

Optionally, the portable object 14 is also adapted for decrypting the encrypted audio and/or video data using the content decrypting key Kc that the portable object 14 determined by itself.

The portable object 14 is an feature that the final user can freely carry. It is a Bluetooth feature.

As a Bluetooth feature, it can have various shapes.

A Bluetooth headphone with earphones or a Bluetooth earpiece can be mentioned.

It can also be a Bluetooth watch or a Bluetooth jewel.

The portable object 14 also includes a Bluetooth interface making it possible to have a contactless proximity communication through a radiofrequency link with the outside.

In order to interact with the terminal 13, the portable object 14 is positioned closer to the terminal to get connected to the respective Bluetooth interfaces and match the terminal 13 and the portable object 14.

In order to match the terminal 13 with the portable object 14, the final user enters, from a man-machine interface provided for the Bluetooth feature, as the portable object 14, a password.

The password is entered using one or several control keys provided on the portable object 14, such as the on/off key, for example, according to a sequence of predefined pressures, using at least one relatively long pressure (for example over one second) and/or at least one relatively short pressure (for example of less than one second).

According to an alternative embodiment, the password is entered using a microphone integrated in the Bluetooth feature, so that the final user delivers a recognised voice message further to a voice recognition application aboard the Bluetooth feature.

According to an advantageous characteristic of the invention, the terminal 13 and the portable object 14 are capable of transmitting data, on the one hand, from the terminal 13 to a portable object 14, relative to the content decrypting keys Kc and service decrypting keys Kx, and on the other hand, from the portable object 14 to the terminal 13, to the content decrypting key Kc, through their respective Bluetooth interfaces.

According to an alternative embodiment (not shown), the terminal 13 and the portable object 14 are capable of transmitting data, on the one hand, from the terminal 13 to the portable object 14, relative to the content Kc and service Ks decrypting keys, through interfaces of the Bluetooth, Wibree, Wifi, Wireless USB, Zigbee, NFC or IR respective types, and on the other hand, from the portable object 14 to the terminal 13 to the content Kc decrypting key through contactless interfaces of another Wibree, Wifi, Wireless USB, Zigbee, NFC or IR of Bluetooth types.

According to another alternative embodiment (not shown), the terminal 13 and the portable object 14 exchange audio data, through another contactless interface available to everyone, such as a Wibree, Wifi, Wireless USB, Zigbee, NFC or IR interface.

According to an alternative embodiment (not shown), the parts of the terminal and those of the portable object explained here-above are reversed. More precisely, the portable object is capable of receiving from outside the system 10, the encrypted audio and/or video data relative to the service ks and content kc decrypting keys. The portable object is adapted for reorienting the data relative to the service Ks and the content Kc decrypting keys to the terminal, for decrypting the encrypted audio and video data using the content decrypting key Kc received from the terminal, and to transmit these, as a whole or partly decrypted, to the terminal. As for the terminal, the latter is capable of determining the decrypting key Kc from data relative to the service decrypting key Ks and content decrypting key Kc received from the portable object, and of receiving the deciphering video and audio data received from the portable object. For this purpose, the portable object and the terminal exchange data relative to the two content Kc and service Ks decrypting keys, through their respective Bluetooth interfaces and the data decrypted audio and video content data. The terminal displays the video data on its own screen and broadcasts the audio data via one or several loudspeakers which it is provided with.

According to still another alternative embodiment (not shown), the parts of the terminal and the portable object as explained here-above are reversed during the operation, in a way known per se, further to an exchange of information determining the one among the terminal 13 or the portable object 14, which plays such or such role within the system 10. Such an alternative assumes that the terminal and the portable object each include means for receiving the encrypted audio and video data from outside the system and data relevant to the content Kc and service Ks decrypting keys, means for determining the content decrypting keys Kc, means for decrypting encrypted audio and video data using a content decrypting key. In addition, the terminal and the portable object each include one or several loudspeakers for broadcasting the audio data and one or several screens for displaying the video data. According to such an alternative, the parts of the terminal and the portable object are exchangeable. In such an alternative embodiment, the tasks to be carried out by each one are either defined and imposed by one of the two entities, i.e. the terminal or the portable object, or distributed as a function of the capacities of each entity. And in the case where both entities are capable, the priority of the execution of tasks is given to the portable object. Thus, the portable object capable of receiving encrypted data Ec executes such a task and not the terminal. In the case where the portable object alone is capable of receiving the encrypted data Ec, the terminal executes the only task of displaying video data supplied unencrypted by the portable object.

As illustrated in FIG. 3, according to a particular embodiment, the portable object 14, constituting a Bluetooth headphone, includes means 32 for processing and controlling data, one or several memories symbolised by only one memory block 34, a signal processing processor 36 (or DSP, the acronym for “Digital Signal Processor”), a communication interface 38 of the Bluetooth type and an integrated loudspeaker 310.

The various elements of the portable object 14 are connected together by a bidirectional internal bus 312.

The means 32 for processing and controlling data are composed of a microprocessor or a logic processing unit. Such means 32 are the central unit for processing and taking decision in the portable object 14. Such means 32 implement an operation system governing the operation thereof.

The memory block 34 includes a non-volatile memory of the ROM (the acronym for “Read Only Memory”) or Flash or another type, and a volatile memory of the RAM (the acronym for “Random Access Memory”) or another type.

It should be reminded that, as known per se, the volatile memory loses data which it stores once it is turned off, more particularly when the portable object 14 is switched off.

The non-volatile memory more particularly stores the operation system, data relative to a predetermined IP (the acronym for “Internet Protocol”) address of the server 12 site which the system must connect to, and a secret algorithm to determine the content Kc decrypting key from the service Ksi decrypting key and the index i identifying the service decrypting key to be used. The IP address collected by the microprocessor 32 before it gets connected through a Bluetooth interface 38, from the terminal 13 to the server 12, and automatically, which means without any operation by the final user.

Preferably, the non-volatile memory stores, in addition, encrypting and decrypting algorithms and secrets required for securing the data to be transferred via the Bluetooth interface 38, to the terminal 13, and to be received from the terminal 13.

The volatile memory temporarily stores data belonging to the calculations carried out by the DSP, data relative to the service decrypting key Ks to be used, and data relating to the content decrypting key Kc to be transmitted to the outside.

The service decrypting key Ks to be used is either transmitted encrypted to the portable object 14 or stored within the portable object 14 to certify the subscription to the broadcasting service.

Preferably, the non-volatile memory securely stores, for example encrypted, the service decrypting key Ks to be used, or all the service decrypting keys Ksi with their associated identifiers i.

The portable object 14 received, from the outside, the index i identifying the service decrypting key Ks to be selected among the set of service decrypting keys Ksi to determine the content decrypting key Kc.

The DSP 36 is intended to carry out any encrypting or decrypting calculation, more particularly the one of the content decrypting key Kc from the identified service decrypting key Ks. To carry out the calculation of the content decrypting key Kc, the DSP 36 carries out the following operation:

Kc=f⁻¹(Xc,Ks).

According to an alternative embodiment, a DSP is provided as means for processing, determining a content decrypting key Kc and controlling data as a whole instead of a microprocessor and a DSP provided in the above-mentioned embodiment.

The loudspeaker 310 is provided for broadcasting, outside, a sound produced from the decrypted audio data.

The decrypted audio data are supplied from the external matched terminal.

Optionally, the portable object 14 further includes a display screen (not shown) to display video data received from the terminal.

The Bluetooth interface 38 is used for communicating, through a short or middle range radiofrequency, for example up to about 10 metres, with the terminal 13.

Optionally, the portable object 14 further integrates a server, for example of the http (the acronym for “HyperText Transfer Protocol”) type. The terminal 13 is connected to the server integrated in the portable object 14, via the Bluetooth wireless connection, to configure the decrypting service or select at least another service provided by the portable object 14 to the outside. The terminal 13 plays the part of a simple relay or gateway between the external communication network and the portable object 14 accessible through the Bluetooth wireless link, as a http client, from a remote server included within the network.

Optionally, the portable object 14 further includes an integrated battery to supply the various elements integrated therein.

Optionally, the portable object 14 is, in addition adapted to decrypt the encrypted data supplied through its Bluetooth interface 38, from the outside terminal, using one or several decrypting key or keys.

The portable object 14 is not expensive and is easily movable with respect to the terminal 13 which it must be matched with, or by remaining connected with the terminal 13, which it is matched to, or possibly another terminal with which it must be matched without executing any handling operation on the terminal 13 (or the terminals implied).

1.-20. (canceled)

21. A system for decrypting encrypted audio and/or video data, including a terminal and at least one portable object, the terminal and/or the portable object including means for receiving encrypted audio and/or video data from outside the system, means for determining at least one decrypting key, and means for decrypting encrypted audio and/or video data, said at least one decrypting key being necessary for decrypting the encrypted audio and/or video data,
wherein the terminal and the portable object each include at least one contactless communication interface for exchanging:
data relative to at least one decrypting key;
encrypted audio and/or video data; and/or
decrypted audio and/or video data (audio);
and wherein the portable object is an accessory, with the portable object including means for securely memorising data.

22. A system according to claim 21, wherein said contactless communication interface is a radiofrequency communication interface belonging to the group of technologies including:
Bluetooth;
Wibree;
Wifi;
Wireless Universal Serial Bus;
Zigbee;
Near Field Communication.

23. A system according to claim 21, wherein the terminal includes means for decrypting the encrypted audio and/or video data, and wherein the portable object includes means for determining a content decrypting key, wherein at least one identifiable service decrypting key is necessary for determining the content decrypting key, and wherein the service and content decrypting keys are necessary for decrypting the encrypted audio and/or video data.

24. A system according to claim 23, wherein the terminal includes:
means for receiving, from outside the system, data relative to said service decrypting key and the content decrypting key;
means for identifying data relative to said service decrypting key as necessary for determining the content decrypting key;
means for routing, through the contactless communication interface, towards the portable object, the data relative to said service decrypting key and the content decrypting key,
and wherein the portable object includes means for receiving, from the terminal, through the contactless communication interface, the data relative to said service decrypting key and the content decrypting key.

25. A system according claim 21, wherein the terminal includes at least one of the devices belonging to the group including:
a mobile telephone,
a personal computer,
a TV set
a decoder,
a personal digital assistant.

26. A portable object for decrypting encrypted audio and/or video data, with the portable object including means for determining at least one decrypting key, said decrypting key being necessary for decrypting the encrypted audio and/or video data,
wherein the portable object includes at least one contactless communication interface for exchanging, outside the portable object:
data relative to at least one decrypting key;
encrypted audio and/or video data; and/or
decrypted audio and/or video data
and wherein the one portable object is an accessory, with the portable object including means for securely memorising data.

27. A portable object according to claim 26, wherein the portable object includes at least one earphone for broadcasting at least some decrypted audio data and/or at least one screen for displaying at least some decrypted video data.

28. A portable object according claim 26, wherein the portable object includes means for encrypting said decrypting key.

29. A portable object according to claim 26, wherein the portable object includes means for decrypting the encrypted audio and/or video data using said decrypting key.

30. A portable object according to claim 26, wherein the portable object includes at least one of the elements belonging to the group including:
an earpiece;
a pair of glasses.
